(19) United States
(12) Patent Application Publication
(10) Pub. No.: US 2019/0331128 A1
(43) Pub. Date: Oct. 31, 2019

(54) TURBOCHARGER

(71) Applicant: MAN Energy Solutions SE, Augsburg (DE)

(72) Inventors: Steffen Braun, Augsburg (DE); Daniel Albrecht, Augsburg (DE); Harald Denkel, Baar (DE); Stefan Weihard, Augsburg (DE); Bernd Haas, Neusäß (DE); Johannes Niebuhr, Augsburg (DE); Urban Spatz, Neusäß (DE)

(73) Assignee: MAN Energy Solutions SE

(21) Appl. No.: 16/395,517

(22) Filed: Apr. 26, 2019

(30) Foreign Application Priority Data
Apr. 27, 2018 (DE) 102018110235.6

(51) Int. Cl. F04D 29/40; F01D 25/24; F02B 33/40

(52) U.S. Cl. CPC F04D 29/403; F02B 33/40; F01D 25/24

(57) ABSTRACT

A turbocharger, with a turbine and a compressor. A turbine housing of the turbine and a compressor housing of the compressor are connected to a bearing housing arranged between the same. A casing surrounds the turbine housing and/or the compressor housing and/or the bearing housing radially outside and axially outside at least in sections, which are connected to the respective housing to be encased via multiple fastening devices. At least one fastening device forms a fixed bearing-like connection and at least one fastening device a loose bearing-like connection of the casing on the respective housing to be encased.

### BACKGROUND OF THE INVENTION

### 1. Field of the Invention

The invention relates to a casing of a turbocharger and to a turbocharger.

### 2. Description of the Related Art

The fundamental construction of a turbocharger is known to the person skilled in the art addressed here. A turbocharger comprises a turbine in which a first medium is expanded and a compressor in which a second medium is compressed, utilising energy extracted in the turbine during the expansion of the first medium. The turbine of the turbocharger comprises a turbine housing and a turbine rotor. The compressor of the turbocharger comprises a compressor housing and a compressor rotor. Between the turbine housing of the turbine and the compressor housing of the compressor a bearing housing is positioned, wherein the bearing housing is connected to the turbine housing and to the compressor housing. In the bearing housing, a shaft is mounted via which the turbine rotor is coupled to the compressor rotor.

During operation of a turbocharger there is a risk that a rotor, for example the turbine rotor or the compressor rotor of the turbocharger breaks and fragments of the rotor strike through the relevant housing, i.e. the turbine housing or the compressor housing. There is then the risk that the fragments of the turbocharger enter the surroundings. In order to take into account this problem of the bursting of a rotor of the turbocharger, the respective housing in turbochargers known from practice is designed in such a manner that a failure of the respective housing need not be expected and even in the event of a breaking of the respective rotor, fragments of the same cannot strike through the respective housing. However, this increases the weight of the turbocharger.

So as not to unnecessarily increase the weight of the turbocharger it is known from practice to equip a turbocharger with a casing which surrounds a turbine housing and/or a compressor housing and/or a bearing housing of the turbocharger radially outside and axially outside at least in sections.

Such casings not only serve for providing a burst protection. Such casings can also serve for thermally insulating assemblies of the turbocharger.

The casing of a turbocharger is connected to the housing of the turbocharger to be encased via multiple fastening devices. During operation of the turbocharger, the housing to be encased is subject to cyclical thermal loads which result in a thermal deformation of the housing to be encased. As a consequence of a heating, the housing to be encased can be expand and as a consequence of a cooling, contract. By way of this, forces are then introduced into the casing or into the fastening devices via which the casing is connected to the housing to be encased, which can result in that the fastening devices, the housing or the casing fail. This is disadvantageous. Furthermore, casings have a tendency towards undesirable vibrations during the operation of the turbocharger.

### SUMMARY OF THE INVENTION

There is a need for improving the connection between a housing of the turbocharger to be encased and a casing which surrounds the same at least in sections. One aspect of the invention is based on creating a new type of turbocharger.

According to one aspect of the invention, the at least one fastening device forms a fixed bearing-like connection and at least one fastening device provides a loose bearing-like connection of the casing to the respective housing to be encased. A fastening device, which forms a fixed bearing-like connection of the casing to the respective housing to be encased prevents a relative movement between the casing and the respective housing to be encased at the point of the mounting. A fastening device, which forms a loose bearing-like connection of the casing to the respective housing to be encased allows a relative movement between the casing and the respective housing to be encased. Because of the fact that at least one fastening device, which serves for fastening the casing to the housing to be encased, forms a fixed bearing-like connection and at least one fastening device, which serves for fastening the casing to the housing to be encased, a loose bearing-like connection of the casing to the respective housing to be encased, forces, which as a consequence of a cyclical thermal load on the housing to be encased act on the casing, the housing and on the fastening devices, can be reduced. Damages to the casing, the fastening device and the housing can thus be avoided. Furthermore, vibrations of the casing are avoided.

According to a first further development of the invention, the or the respective loose bearing-like connection allows a translational relative movement between the casing and the respective housing to be encased in the radial direction. According to a second further development of the invention, the or the respective loose bearing-like connection allows a translational relative movement between the casing and the respective housing to be encased in the axial direction. Both advantageous further developments allow a defined relative movement between the housing to be encased and the casing, in order to thus offset cyclical thermal loads on the housing to be encased and by way of this reduce forces introduced into the casing or into the fastening devices.

In particular when the or the respective loose bearing-like connection allows a translational relative movement between the casing and the respective housing to be encased in the radial direction, it is preferentially provided that on at least one axial wall of the casing a fastening device in each case provides a fixed bearing-like connection and in each case a fastening device provides a loose bearing-like connection. By way of this, a relative movement between the casing and the housing to be encased can be made particularly easily and reliably possible in the radial direction.

In particular when the or the respective loose bearing-like connection allows a translational relative movement between the casing and the respective housing to be encased in the axial direction it is preferentially provided that on an axial wall of the casing a fastening device provides a fixed bearing-like connection and on a radial wall of the casing a fastening device provides a loose bearing-like connection. By way of this, a relative movement can be made possible between the casing and the housing to be encased in the axial direction in a simple and reliable manner.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1 is a lateral view of a turbocharger according to one aspect of the invention in the region of a housing of the turbocharger and of a casing of the housing in axial viewing direction;

FIG. 2 is a cross section of a first detail of FIG. 1; and

FIG. 3 is a cross section of a second detail of FIG. 1.

### DETAILED DESCRIPTION OF THE PRESENTLY PREFERRED EMBODIMENTS

The fundamental construction of a turbocharger is familiar to the person skilled in the art addressed here. Accordingly, a turbocharger comprises a turbine for expanding a first medium, in particular for expanding exhaust gas, and a compressor for compressing a second medium, in particular for compressing charge air, utilising energy extracted in the turbine during the expansion of the first medium.

The turbine comprises a turbine rotor and a turbine housing. The compressor comprises a compressor rotor and a compressor housing. The turbine rotor and the compressor rotor are coupled via a shaft mounted in a bearing housing of the turbocharger, wherein the bearing housing is connected both to the turbine housing and also to the compressor housing.

When during the operation the turbine rotor or the compressor rotor breaks, fragments of the same can strike through the respective housing, i.e. the turbine housing or the compressor housing, and enter the surroundings. This has to be avoided for the purpose of which it is known to equip a turbocharger with a casing which surrounds the turbine housing and/or the compressor housing and/or the bearing housing of the turbocharger.

Preferentially, a separate casing each is employed in the region of the turbine housing and of the compressor housing which surrounds the respective casing of the turbocharger to be encased radially outside and axially outside at least in sections.

Such casings provide a burst protection and can also serve for thermally insulating and sound insulating assemblies of the turbocharger.

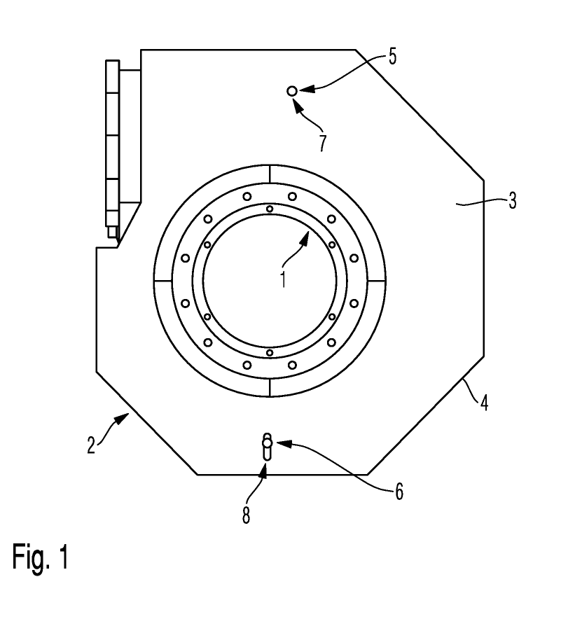

FIG. 1 shows a lateral view of a turbocharger in the region of a turbine housing 1 and of a casing 2, which surrounds the turbine housing 1 on the outside at least in sections. The concrete construction of the casing 2 is of no significance regarding the invention present here.

FIG. 1 shows a lateral view in the axial viewing direction of the encased housing 1 of a turbocharger, which is surrounded by the casing 2 on the outside at least in sections. The encased housing 1 is in particular the turbine housing of the turbine of a turbocharger.

The casing 2 comprises axial walls 3 and radial walls 4. Accordingly an axial wall 3 of the casing 2 is arranged preferentially on each axial side of the housing 1 to be encased, which axially covers the respective housing 1 to be encased at least in sections. Radially outside, a radial wall 4 of the casing 2 covers the respective housing 1 to be encased at least in sections.

The casing 2 is connected to the housing 1 to be encased via fastening devices 5, 6. Here, both at least one axial wall 3 of the casing 2 as well as also the radial wall 4 of the casing 2 can be connected to the housing to be encased via fastening devices.

In FIG. 1, fastening devices 5, 6 are shown via which the axial wall 3 that is visible in FIG. 1 is connected to the housing 1 to be encased.

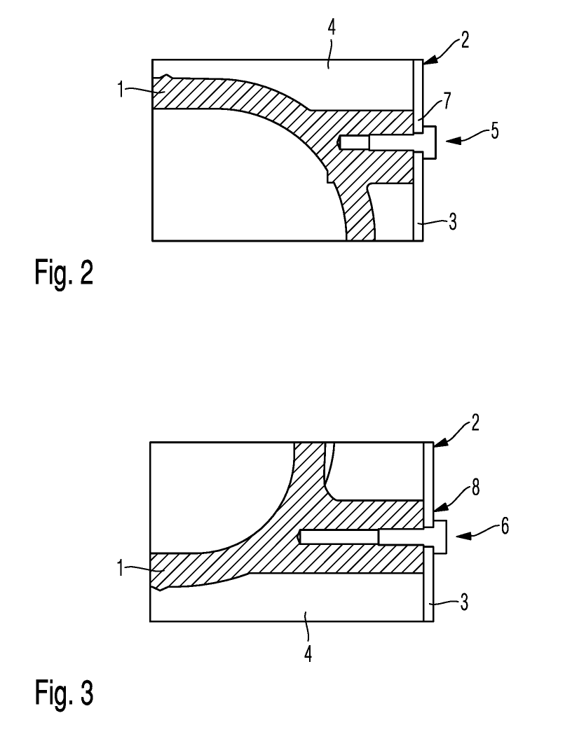

FIG. 2 shows a cross section through the arrangement of FIG. 1 in the region of the fastening device 5. FIG. 3 shows a cross section through the arrangement of FIG. 1 in the region of the fastening device 6.

According to one aspect of the invention, it is provided that at least one fastening device, which serves for fastening the casing 2 to the housing 1 to be encased, forms a fixed bearing-like connection of the casing 2 on the housing 1 to be encased, and that at least one further fastening device forms a loose bearing-like connection of the casing 2 on the respective housing 1 to be encased.

In FIG. 1, the fastening device 5 forms a fixed bearing-like connection and the fastening device 6 a loose bearing-like connection of the casing 2 on the respective housing 1 to be encased. The fastening devices 5, 6 extend through the casing 2 into the housing 1 to be encased. The fastening device 5, which forms a fixed bearing-like connection of the casing 2 on the housing 1 to be encased and extends through the axial wall 3 of the casing 2 into the housing 1 to be encased and prevents a local relative movement between the casing 2 and the respective housing 1 to be encased. The fastening device 6, by contrast, which forms a loose bearing-like connection of the casing 2 on the housing 1 to be encased and extends through the axial wall 3 of the casing 2 into the housing 1 to be encased, allows a local relative movement between the casing 2 and the housing 1 to be encased in a single translational direction.

In the exemplary embodiment of FIGS. 1 to 3, the respective loose bearing-like connection in the region of the fastening device 6 allows a translational relative movement between the casing 2 and the respective housing 1 to be encased in the radial direction. Here it is provided in the exemplary embodiment of FIGS. 1 to 3 that on axial walls 3 of the casing 2 located opposite one another a fastening device 5 in each case provides a fixed bearing-like connection and in each case a fastening device 6 a loose bearing-like connection.

From FIG. 1 it is evident that the fastening devices 5, 6 acting on the axial wall 3 that is visible in FIG. 1 on the one hand form the fixed bearing-like connection in the region of the fastening device 5 and on the other hand the loose bearing-like connection in the region of the fastening device 6, lie on an axis extending in the radial direction. Here, the fastening device 5, which forms the fixed bearing-like connection, extends without play or almost without play through a recess in the axial wall 3 into the housing 1 to be encased. The fastening device 6 by contrast, which forms the loose bearing-like connection of the casing 2 on the housing 1 to be encased, extends through a recess of the respective axial wall 3 formed as elongated hole 8 into the housing 1 to be encased and is guided in the elongated hole 8.

The fastening devices 5, which provide fixed bearing-like connections and which are formed on axial walls 3 located opposite one another, lie on a first axis extending in the axial direction. Loose bearing-like connections formed on axial walls 3 located opposite one another or the fastening devices 6, which form such loose bearing-like connections, lie on a second axis extending in the axial direction, which preferentially run parallel to the first axis.

The elongated hole 8, which is formed in the axial wall 3 and together with the fastening device 6 provides the loose bearing-like connection extends in the radial direction of the housing 1 to be encased. In the exemplary embodiment of FIG. 1, the respective loose bearing-like connection accordingly allows a translational relative movement between the casing 2 and the respective housing 1 to be encased in the radial direction.

Alternatively it is also possible that a respective loose bearing-like connection allows a translational relative movement between the casing 2 and the respective housing 1 to be encased in the axial direction.

In particular when a loose bearing-like connection allows a translational relative movement between the casing 2 and the respective housing 1 to be encased in the axial direction it is provided, in particular, that on an axial wall 3 of the casing 2 a fastening device, which extends through the wall 3 of the casing 2 into the housing 1 to be encased, provides a fixed bearing-like connection and that on a radial wall of the casing 2 a fastening device, which extends through the radial wall 4 of the casing 2 into the housing 1 to be encased, provides a loose bearing-like connection. To this end, an elongated hole extending in the axial direction can be formed in the region of the radial wall 4 in which the fastening device is guided.

With the invention, a defined relative movement between the housing 1 to be encased and the casing 2 is possible in particular with a housing 1 of a turbocharger to be encased exposed to cyclical thermal loads. Forces, which brought about by a cyclical thermal loading of the housing 1 can be introduced into the casing 2 via the fastening devices can be reduced. Damages to the housing 1 to be encased, the fastening devices 4, and the casing 2 can thus be avoided. At least one fastening device forms a fixed bearing-like and at least one other fastening device provides a loose bearing-like connection of the casing 2 on the housing 1 in order to make possible a defined relative movement between the casing 2 and the housing 1 to be encased. Furthermore, vibrations of the casing 2 are avoided.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turbocharger, comprising:
a turbine configured to expand a first medium;
a compressor configured to compress a second medium utilising energy extracted in the turbine during expansion of the first medium;
a turbine housing of the turbine;
a compressor housing of the compressor;
a bearing housing arranged between and connected to the turbine housing and the turbine housing;
a casing configured to surround one or more of radially outside and axially outside at least in sections the turbine housing, the compressor housing, and the bearing housing,
multiple fastening devices configured to connect the casing to the respective housing to be encased;
at least one first fastening device of the multiple fastening devices configured as a fixed bearing-like connection; and
at least one second fastening device of the multiple fastening devices configured as a loose bearing-like connection of the casing on the respective housing to be encased.

2. The turbocharger according to claim 1, wherein
the at least one first fastening device prevents a relative movement between the casing and the respective housing to be encased, and
the at least one second fastening device allows a relative movement between the casing and the respective housing to be encased in a translational direction.

3. The turbocharger according to claim 1, wherein the at least one second fastening device allows a translational relative movement between the casing and the respective housing to be encased in a radial direction.

4. The turbocharger according to claim 3, wherein on at least one axial wall of the casing the at least one first fastening device provides a fixed bearing-like connection and the at least one second fastening device a loose bearing-like connection.

5. The turbocharger according to claim 3, wherein on axial walls of the casing located opposite one another, a respective first fastening device provides a fixed bearing-like connection and a respective second fastening device provides a loose bearing-like connection.

6. The turbocharger according to claim 3, wherein a fixed bearing-like connection formed on an axial wall and a respective loose bearing-like connection formed on a same axial wall lie on an axis that extends in a radial direction.

7. The turbocharger according to claim 1, wherein the loose bearing-like connection allows a translational relative movement between the casing and the respective housing to be encased in an axial direction.

8. The turbocharger according to claim 7, wherein on an axial wall of the casing a respective fastening device provides a fixed bearing-like connection and on a radial wall of the casing and a respective fastening device provides a loose bearing-like connection.

9. The turbocharger according to claim 1, wherein a respective first fastening device, which forms a fixed bearing-like connection, extends without play or almost without play through a recess in a respective wall of the casing.

10. The turbocharger according to claim 1, wherein a respective second fastening device, which forms a loose bearing-like connection, extends through an elongated hole in a respective wall of the casing.
